(19) United States
(12) Patent Application Publication
(10) Pub. No.: US 2020/0409184 A1
(43) Pub. Date: Dec. 31, 2020

(54) PINHOLE GLASSES USING THREE-DIMENSIONAL INTERSECTION BETWEEN HORIZONTAL AND VERTICAL COMB TEETH

(71) Applicant: Doo-won HWANG, Busan (KR)

(72) Inventor: Doo-won HWANG, Busan (KR)

(21) Appl. No.: 16/975,858

(22) PCT Filed: Oct. 14, 2019
(86) PCT No.: PCT/KR2019/013426

§ 371 Date: Aug. 26, 2020

(30) Foreign Application Priority Data
Nov. 1, 2018 (KR) 10-2018-0132920

(51) Int. Cl. G02C 7/16

(52) U.S. Cl. CPC G02C 7/16

(57) ABSTRACT

Pinhole glasses include an eyeglass frame, a processed lens which is fixed to the eyeglass frame and made of an opaque material, and a plurality of pinholes formed at the processed lens. In order to form the pinholes, based on eyes of a user, a plurality of longitudinal patterns are formed on the inner side thereof at regular intervals and a plurality of transverse patterns are formed on the outer side thereof at regular intervals to intersect the longitudinal patterns, thereby forming a plurality of square-shaped pinholes.

### TECHNICAL FIELD

The present invention relates to pinhole glasses using three-dimensional intersection between horizontal and vertical comb teeth, and more particularly, to pinhole glasses using three-dimensional intersection between horizontal and vertical comb teeth, in which pinholes are formed in a three-dimensional structure in which the plurality of horizontal and vertical comb teeth overlap in two layers, the horizontal and vertical comb teeth each have an inclined surface with a predetermined gradient such that it is possible to effectively block reflective light directed toward a pupil and thus to obtain an excellent effect of preventing light blindness, and the pinholes provide a dual three-dimensional effect of the structure of the horizontal and vertical comb teeth such that a magnifier effect, which allows a user to see text clearly, may also be expected.

### BACKGROUND ART

Recently, glasses using a pinhole effect are used to correct myopia or hyperopia or to recover eyes with fatigue. The pinhole effect refers to an effect that enables a user to see an object clearly because when the user sees the object through small holes drilled by a pin, dissipated focal points of the user's lens are gathered in one place and eye muscles are normalized autonomously.

As described above, the glasses using the pinhole effect enable the user to read even small letters by adjusting the user's eye muscles and lenses even though the lenses of the glasses have no power.

Further, on the principle of the lens, the lens becomes thicker when the user sees a close place, and the lens becomes thinner when the user sees a distant place.

However, eyesight decreases when the lens is hardened due to an acquired influence. However, when the user wears the glasses using the pinhole effect, the motion of the lens is activated because of light introduced through the holes, thereby reducing fatigue of the eyes, maintaining health of the eyes, and restoring eyesight by relaxing nerves of the eyes.

The pinhole glasses using the pinhole effect in the related art include an eyeglass frame, and processed lenses fixed to the eyeglass frame, the processed lens is made of an opaque material that does not transmit light, and the processed lens has a plurality of pinholes that transmits light.

As described above, it is possible to obtain the effect of enabling the user to see an object clearly by reducing the passage of light through the pinholes, but the light directed toward the pupil passes through the pinholes, which causes a problem in that light blindness occurs and the object appears blurred.

Further, the pinholes in the related art are small holes, and the holes are separated from one another, and as a result, there is a problem in that an appearance of an object appears to wave when the user sees the object while moving the holes from place to place.

Meanwhile, the present applicant has suffered from acute presbyopia and difficulty in seeing fine print in a book or newspaper, and became interested in eye motions, thus using the pinhole glasses.

However, the present applicant did not obtain a special effect because the pinhole glasses in the related art only has a shape in which small holes are simply formed in a flat surface, and thus the present applicant became interested in and performed studies on the manufacture of a three-dimensional pinhole glasses that may provide a stronger stimulus to the eyes.

In the meantime, the present applicant found that thin gaps between comb teeth had the effect of the pinholes, and the pinholes made by overlapping the teeth of the two combs had a certain effect in comparison with the pinholes in the related art. Further, through a number of trial and error, the present applicant saw letters through gaps between overlapping razor blades of a disposable razor with the three razor blades overlapped and found that the letters were clearly visible. Keeping this in mind, the present applicant tried to make pinhole glasses by overlapping two comb-toothed plates (plates with horizontal comb teeth and vertical comb teeth) arranged by tilting the horizontal and vertical comb teeth laterally like a vent of an air conditioner or a razor with blades overlapping in three layers, and found that the pinhole glasses had a very strong magnifier effect.

Further, the present applicant has performed various experiments after making the pinhole glasses according to the present invention, and as a result, it has been found that a rectangular pinhole is formed when the comb-toothed plates are erected and overlapped horizontally and vertically. In addition, the present applicant found that a parallelogrammatic or trapezoidal pinhole is formed when the comb-toothed plates are inclined obliquely and overlapped with each other in a slanted shape, thereby making the magnifier effect stronger and a visual field wider, and thus the present applicant completed the present invention.

Meanwhile, the magnifier allows a user to see an object well but has a fatal defect that makes the eyes worse. This is because the magnifier receives light as it is without reflecting the light. It is a known fact that when the eyes are excessively exposed to bright light, the eyes become tired and the eyesight deteriorates.

Patients with presbyopia are not caused due to the small letters not being visible, but because the patients see blurry letters due to reflected light in many cases.

Because the pinhole glasses receive light in much smaller amount than the lens, the pinhole glasses may help patients with presbyopia to see the letters. However, since the pinhole glasses in the related art merely have the holes formed in the flat surface, the reflection of light directed toward a center of the hole cannot be avoided even though the hole is small.

In contrast, the present invention may provide the dual structure having the inclined surface, thereby effectively blocking the reflective light, and thus achieving an excellent effect of preventing light blindness. In addition, in comparison with the pinhole glasses in the related art, the dual three-dimensional effect of the comb structure implements a much better magnifier effect that enables a user to see the letters largely and clearly, such that the pinhole glasses according to the present invention advantageously has an effect obtained by combining an advantage of lens glasses and an advantage of pinhole glasses.

### DISCLOSURE

### Technical Problem

The present invention has been made in an effort to solve the above-mentioned problems, and an object of the present invention is to provide pinhole glasses using three-dimensional intersection between horizontal and vertical comb teeth, in which the pinhole glasses have a three-dimensional structure in which a plurality of vertical comb teeth is formed at predetermined intervals inside a region of a user's eye, a plurality of horizontal comb teeth is formed at predetermined intervals outside the region of the user's eye, the vertical comb teeth and the horizontal comb teeth overlap one another, and the vertical and horizontal comb teeth each has a predetermined gradient to form a parallelogrammatic or trapezoidal pinhole, such that light directed squarely toward the pupil collides with an inclined surface so as to be reflected or refracted by the inclined surface and then reaches the pupil, thereby preventing light blindness of the eyes and allowing the user to see an object more clearly.

### Technical Solution

In order to achieve the above-mentioned object, pinhole glasses using three-dimensional intersection between horizontal and vertical comb teeth according to the present invention include an eyeglass frame, processed lenses fixed to the eyeglass frame and made of an opaque material, and a plurality of pinholes formed in the processed lenses, in which in order to form the pinholes, a plurality of vertical comb teeth is formed at predetermined intervals inside a region of a user's eye, and a plurality of horizontal comb teeth is formed at predetermined intervals outside the region of the user's eye and intersects the vertical comb teeth, such that the plurality of quadrangular pinholes is formed.

Further, the vertical comb tooth or the horizontal comb tooth may be formed such that a thickness of an inner end thereof is relatively larger than a thickness of an outer end thereof, or the vertical comb tooth or the horizontal comb tooth may be symmetrically formed such that a width thereof is gradually decreased toward an intermediate length.

In addition, the vertical comb tooth and the horizontal comb tooth may have predetermined gradients to form inclined surfaces.

Further, the vertical comb teeth or the horizontal comb teeth are arranged with a difference in height at predetermined intervals, and the interval of the difference in height is selected as 0.5 to 1 mm.

In addition, the horizontal comb tooth may be stepped in an inclined oblique direction, and a width of an upper portion of the horizontal comb tooth may be relatively larger than a width of a lower portion of the horizontal comb tooth.

### Advantageous Effects

As described above, according to the present invention, the pinhole glasses have a three-dimensional structure in which the plurality of vertical comb teeth is formed at predetermined intervals inside the region of the user's eye, the plurality of horizontal comb teeth is formed at predetermined intervals outside the region of the user's eye, the vertical comb teeth and the horizontal comb teeth overlap one another, and the vertical and horizontal comb teeth each has a predetermined gradient to form the parallelogrammatic or trapezoidal pinhole, such that the light directed squarely toward the pupil collides with the inclined surface so as to be reflected by the inclined surface and then reaches the pupil, thereby preventing light blindness of the eyes and allowing the user to see an object more clearly.

Further, the present invention may be used as a substitute for a magnifier when a user with presbyopia reads a book or newspaper and may adjust a focal point by a magnifier effect without a lens. Therefore, if the user reads a book over a long period of time while using the pinhole glasses according to the present invention, an effect of moving the eyes may be achieved. In addition, the pinhole glasses according to the present invention may be advantageously used as a substitute for safety glasses when the user watches light emitting devices such as TVs, computers, mobile phones, and movies because the pinhole glasses have a strong function of preventing light blindness.

### DESCRIPTION OF DRAWINGS

FIG. 1 is a perspective view illustrating pinhole glasses according to the present invention.

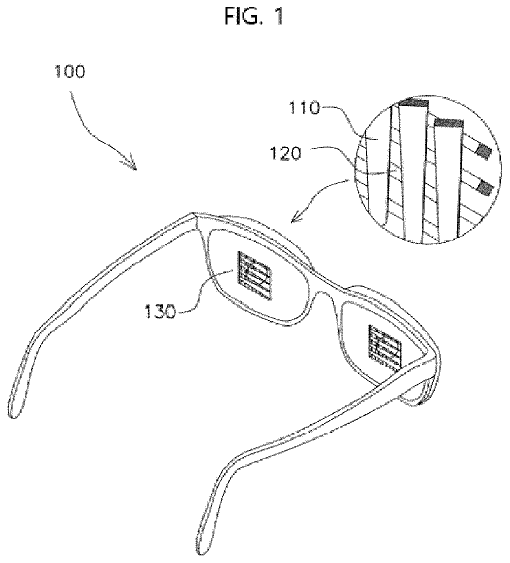

FIG. 2 is a perspective view illustrating an exemplary embodiment of a coupling structure between vertical and horizontal comb teeth for a pinhole structure according to the present invention.

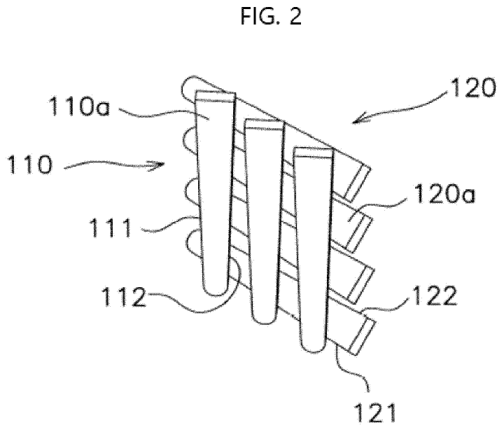

FIG. 3 is a perspective view illustrating another exemplary embodiment of the coupling structure between the vertical and horizontal comb teeth for the pinhole structure according to the present invention.

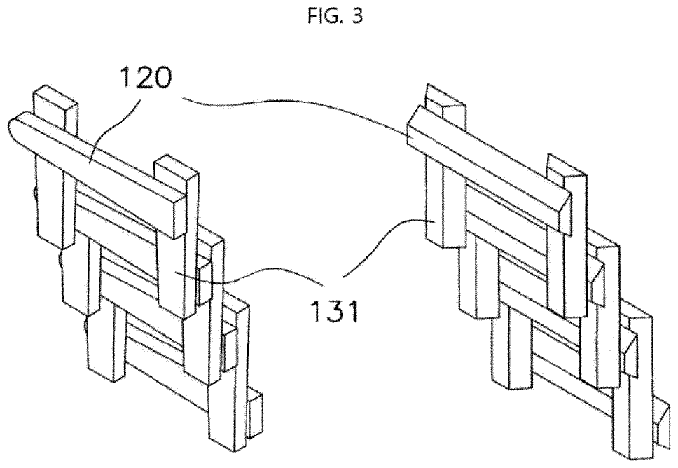

FIG. 4 is a perspective view illustrating still another exemplary embodiment of the coupling structure between the vertical and horizontal comb teeth for the pinhole structure according to the present invention.

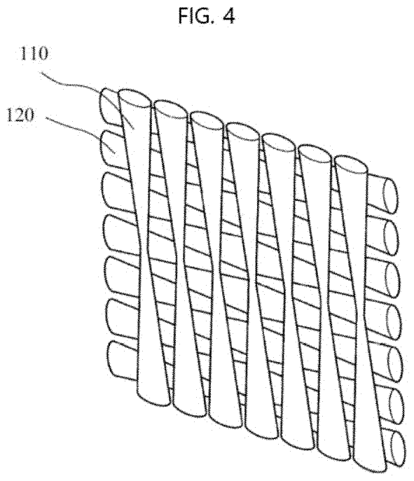

### BEST MODE

The present invention, which is provided to achieve the aforementioned object and effect, will be described below in more detail with reference to exemplary embodiments.

Pinhole glasses 100 using three-dimensional intersection between horizontal and vertical comb teeth according to the present invention include an eyeglass frame, processed lenses fixed to the eyeglass frame and made of an opaque material, and a plurality of pinholes formed in the processed lenses, in which in order to form the pinholes, a plurality of vertical comb teeth 110 is formed at predetermined intervals inside a region of a user's eye, and a plurality of horizontal comb teeth 120 is formed at predetermined intervals outside the region of the user's eye and intersects the vertical comb teeth 110, such that the plurality of quadrangular pinholes is formed.

In this case, the processed lens has a through hole larger than the pupil, the plurality of pinholes is formed in the through hole by the plurality of vertical comb teeth 110 and the plurality of horizontal comb teeth 120, and the vertical comb teeth 110 and horizontal comb teeth 120 are fixed to a frame 130 positioned in an inner rim of the through hole. Of course, the vertical and horizontal comb teeth 110 and 120 may be fixed to the frame 130 by various bonding means (thermal bonding, a bonding agent, etc.), and the frame 130 is also fixed to the processed lens by a bonding means.

The plurality of vertical comb teeth 110 is disposed at predetermined intervals. In this case, a thickness of an inner end 111 (one end close to the pupil) of the vertical comb tooth 110 may be relatively larger than a thickness of an outer end 112 of the vertical comb tooth 110. This is to block the light directed toward the pupil by using a comb tooth surface (a flat surface of the vertical comb tooth) and obtain an effect of diffusing a visual field to a center of the pupil.

Further, in order to meet the above-mentioned principle, the horizontal comb tooth 120 may also be configured such that a thickness of an inner end 121 of the horizontal comb tooth 120 is relatively larger than a thickness of an outer end 122 of the horizontal comb tooth 120.

In this case, a width of each of the vertical and horizontal comb teeth 110 and 120 is gradually increased or decreased in a direction from one end to the other end (a longitudinal direction), such that a size of the pinhole formed by the intersection between the vertical and horizontal comb teeth 110 and 120 is gradually increased or decreased at a predetermined ratio. There is a progressive multifocal effect in which brightness and clarity vary depending on the size of the pinhole, and a magnifier effect that allows a nearby object to be largely and clearly visible, thereby providing an effect of allowing a user to see and read the text largely and more easily.

Further, the vertical comb tooth 110 or horizontal comb tooth may be configured to be formed in a symmetrical shape in which a width thereof is gradually decreased toward an intermediate length.

In addition, the vertical comb teeth 110 and the horizontal comb teeth 120 may be spaced apart from one another at predetermined intervals instead of being in close contact with one another. This is to induce a visual field and allow the user to see characteristics or objects clearly when the user sees the objects.

Further, the vertical and horizontal comb teeth 110 and 120 may have predetermined gradients to form inclined surfaces 110a and 120a. This is to prevent light blindness by more effectively reflecting or refracting the light directed squarely toward the pupil and to allow the user to see the object more clearly.

In addition, the vertical comb teeth 110 or the horizontal comb teeth 120 may be arranged with a difference in height at predetermined intervals, and the interval of the difference in height is selected as 0.5 to 1 mm. This is because the larger the interval of the difference in height, the larger the amount of light to be introduced, and the brighter the visual field, while the sharpness of the visible text is lowered. On the contrary, the smaller the interval of the difference in height, the darker the visual field, but the higher the clarity of the text.

Therefore, it is better for the user with myopia, who cannot see a distant object, to have the pinhole glasses in which the difference in interval is large and the visual field is bright. It is better for the user with severe presbyopia, who cannot see a close object, to have the pinhole glasses in which the difference in interval is small, and the visual field is dark, but the letters can be seen clearly.

Further, the horizontal comb tooth 120 is stepped in an inclined oblique direction, and a width of an upper portion of the horizontal comb tooth 120 is relatively larger than a width of a lower portion of the horizontal comb tooth 120.

In this case, in order for the horizontal comb tooth 120 to be stepped, a plurality of stepped plates 131 is formed in the frame 130, such that the horizontal comb teeth 120 have a stepped structure by the stepped plates 131. The horizontal comb tooth 120 is inclined in a direction toward the user's nose instead of having a horizontal structure, such that the magnifier effect of the pinhole is further enhanced, and the visual field is also widened.

According to the present invention as described above, the comb tooth holes, i.e., the pinholes are formed as the vertical comb teeth 110 and the horizontal comb teeth 120 intersect one another, each of the vertical and horizontal comb teeth 110 and 120 is formed in the form of an elongated and thin beam or rod of which a width is decreased from one end to the other end, or each of the vertical and horizontal comb teeth 110 and 120 is formed in the form of a butterfly symmetrical with respect to a vertical axis so that a width thereof is gradually decreased toward the intermediate length, such that because of the shape in which the widths of the vertical and horizontal comb teeth 110 and 120 are gradually decreased and increased, the progressive multifocal effect is generated in which the pinholes formed by the intersection between the vertical and horizontal comb teeth are also gradually increased and decreased.

That is, since the pinhole glasses in the related art have a simple flat structure, light is not properly controlled. Therefore, when a user reads a book, there occurs light blindness caused because light is severely reflected in a specific portion. Further, because the pinholes are disconnected, when the user reads a book, the letters move like a wave while appearing and disappearing. In contrast, according to the pinhole glasses according to the present invention, since the long and thin gaps intersect one another in two layers vertically and horizontally to form the pinholes, there occurs no wave caused by the disconnection between the pinholes. In addition, since the pinhole glasses according to the present invention precisely control light by means of the two-layered structure, there occurs no light blindness caused because a specific portion appears excessively bright.

The present invention has been described above with reference to the limited exemplary embodiments, but the present invention is not limited thereto. The exemplary embodiments may be variously changed or modified by those skilled in the art to which the present invention pertains within the technical spirit of the present invention and within the scope equivalent to the appended claims.

### DESCRIPTION OF MAIN REFERENCE NUMERALS OF DRAWINGS

100: Pinhole glasses according to present invention
110: Vertical comb tooth
120: Horizontal comb tooth
110a, 120a: Inclined surface
111, 121: Inner end
112, 122: Outer end
130: Frame
131: Stepped plate

1-5. (canceled)

6. Pinhole glasses using three-dimensional intersection between horizontal and vertical comb teeth, the pinhole glasses comprising:
an eyeglass frame;
processed lenses fixed to the eyeglass frame and made of an opaque material; and
a plurality of pinholes formed in the processed lenses,
wherein in order to form the pinholes, a plurality of vertical comb teeth 110 are formed at predetermined intervals inside a region of a user's eye, and a plurality of horizontal comb teeth 120 are formed at predetermined intervals outside the region of the user's eye and intersects the vertical comb teeth 110, such that the plurality of quadrangular pinholes are formed.

7. The pinhole glasses of claim 6, wherein the vertical comb tooth 110 or the horizontal comb tooth 120 are formed such that a thickness of an inner end 111 or 121 thereof is relatively larger than a thickness of an outer end 112 or 122 thereof, or the vertical comb tooth 110 or the horizontal comb tooth 120 are symmetrically formed such that a width thereof is gradually decreased toward an intermediate length.

8. The pinhole glasses of claim 6, wherein the vertical comb tooth 110 and the horizontal comb tooth 120 have predetermined gradients to form inclined surfaces 110a and 120a.

9. The pinhole glasses of claim 6, wherein the vertical comb teeth 110 or the horizontal comb teeth 120 are arranged with a difference in height at predetermined intervals, and the interval of the difference in height is selected as 0.5 to 1 mm.

10. The pinhole glasses of claim 8, wherein the horizontal comb tooth 120 is stepped in an inclined oblique direction, and a width of an upper portion of the horizontal comb tooth 120 is relatively larger than a width of a lower portion of the horizontal comb tooth 120.
